(19) United States
(12) Patent Application Publication
(10) Pub. No.: US 2024/0016575 A1
(43) Pub. Date: Jan. 18, 2024

(54) METHOD AND APPARATUS FOR DENTAL CROWN RESTORATIONS USING PREFABRICATED SLEEVE-CROWN PAIRS

(71) Applicant: Perfect Fit Crowns LLC, Royal Palm Beach, FL (US)

(72) Inventors: Stephen A. Ziskind, Elkton, MD (US); Robin A. Carden, San Juan Capristrano, CA (US)

(21) Appl. No.: 18/351,383

(22) Filed: Jul. 12, 2023

Related U.S. Application Data
(60) Provisional application No. 63/368,228, filed on Jul. 12, 2022.

(51) Int. Cl. A61C 5/30

(52) U.S. Cl. CPC A61C 5/30

(57) ABSTRACT

A dental restoration device includes a sleeve having an exterior surface and an interior pocket that is at least partially filled with a dental cement and a crown having an exterior surface and an interior pocket that is at least partially filled with a dental cement, the crown abutting the sleeve. The sleeve forms an outer surface of the dental restoration device on a gingival-facing part of thereof while the crown forms the outer surface of the dental restoration on the occlusal side thereof. The crown has an occlusal surface and a sidewall surface forming the interior pocket therein. The sleeve is substantially ring-shaped and the crown is substantially cup shaped.

### CROSS-REFERENCE TO RELATED APPLICATION

The present application is based on provisional application Ser. No. 63/368,228, filed Jul. 12, 2022, the entire contents of which are herein incorporated by reference.

### TECHNICAL FIELD

The present disclosure relates to dental crown restorations and, more specifically, to methods and apparatuses for dental crown restorations using prefabricated sleeve-crown pairs.

### DISCUSSION OF THE RELATED ART

A dental crown is a dental restoration that is installed over a natural tooth or dental implant so as to provide a restored functional surface and a natural and healthy aesthetic appearance. Prior to applying a dental crown to a natural tooth, the tooth is first prepared by grinding down the affected tooth to a peg or post-shaped element that is free of disease and is structurally sound. Thereafter, intra-oral digital scans, measurements and/or impressions of the teeth are taken and the coloring of the surrounding teeth is measured. This information is provided to a lab that fabricates a crown that is customized to the shape of the prepared tooth, the ideal final shape of the prepared tooth, the spacing of the mouth and teeth around the prepared tooth, and the color of the surrounding teeth.

Custom fabrication of the crown, however, is time consuming and expensive and requires that the patient be brought in on multiple occasions. On a first visit, the patient may consult with the dentist and a course of treatment may be determined. On this visit or on a second visit, the affected tooth may be prepared and impressions may be taken. A temporary crown may then be installed on the prepared tooth. If the temporary crown falls out prior to the installation of the permanent crown, which is not unusual, then an emergency visit to the dentist's office for repair or replacement may be required. After the final crown is custom fabricated, the patient returns to the dentist's office to have the temporary crown removed and the custom crown installed. If the custom crown fails to fit properly during installation, which may be possible if a bad impression was taken or the crown was made improperly by the lab, additional time is required to replace the custom crown, the patient may require a new temporary crown and another visit to place the replacement crown. Similar problems may occur if the color of the crown does not match that of the surrounding teeth. It is also possible for the prepared tooth to change position in the time between the preparing of the tooth and the installation of the custom crown, as the prepared tooth no longer has the constant opposing force of the opposite teeth. This change in position may cause the custom crown to either not fit or fit awkwardly, requiring trimming or polishing during installation, or in extreme cases, the need for a new crown to be made.

One option for providing single-visit dental crowns is in-office/chairside milling. According to this approach, an intraoral scanning device is used to image the patient's mouth with the prepared tooth. The image is then sent to a local workstation where the design for the crown can be customized and approved. From there, the digital design is sent to a chairside mill that automatically grinds out the crown based on the design. The crown may then be prepared, directly pigmented, glazed, and polished and then its fit may be tested in the patient's mouth. The crown may then be installed in the patient's mouth in that same visit.

While chairside milling may be effective at reducing the number of visits needed to perform the restoration, this approach is time consuming (it could take more than 90 minutes to perform chairside milling), requires significant training of the dentist and dental staff, and requires significant capital investment on the part of the treating dentist.

### SUMMARY

A dental restoration device includes a sleeve having an exterior surface and an interior pocket that is at least partially filled with a dental cement; and a crown having an exterior surface and an interior pocket that is at least partially filled with a dental cement, the crown abutting the sleeve. The sleeve forms an outer surface of the dental restoration device on a gingival-facing part of thereof while the crown forms the outer surface of the dental restoration on the occlusal side thereof. The crown has an occlusal surface and a sidewall surface forming the interior pocket therein. The sleeve is substantially ring-shaped and the crown is substantially cup shaped.

A method of performing a dental restoration includes preparing an affected tooth; filling a substantially ring-shaped sleeve with a first light-curing dental cement; placing the sleeve over the prepared tooth such that a top of the prepared tooth extends through the ring-shape of the sleeve; curing the first light-curing dental cement though an opening of the sleeve; filling a substantially cup-shaped crown with a second light-curing dental cement; placing the filled crown over the prepared tooth and sleeve; and curing the second light-curing dental cement.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a symbolic illustration of a diseased or damaged tooth in accordance with exemplary embodiments of the present disclosure;

FIG. 2 is a symbolic illustration of a prepared tooth in accordance with exemplary embodiments of the present disclosure;

FIG. 3 is an image of a sleeve in accordance with exemplary embodiments of the present disclosure;

FIG. 4 shows a first side of the sleeve in accordance with exemplary embodiments of the present disclosure;

FIG. 5 shows a second side of the sleeve in accordance with exemplary embodiments of the present disclosure;

FIG. 6 shows a first side of the sleeve having a symbolic representation of a crown connected thereto;

FIG. 7 shows a second side of the sleeve having a symbolic representation of a crown connected thereto;

FIG. 8 shows a model of a prepared tooth with a sleeve affixed thereto and a crown by its side;

FIG. 9 is a closeup view of the model shown in FIG. 8;

FIG. 10 is a first side view of the crown in accordance with exemplary embodiments of the present disclosure;

FIG. 11 is a second side view of the crown in accordance with exemplary embodiments of the present disclosure;

FIG. 12 is a third side view of the crown in accordance with exemplary embodiments of the present disclosure;

FIG. 13 is a first side view of the crown having a symbolic representation of the sleeve connected thereto;

FIG. 14 is a second side view of the crown having a symbolic representation of the sleeve connected thereto;

FIG. 15 is the model shown in FIG. 8 with the crown attached to the sleeve in accordance with exemplary embodiments of the present disclosure;

FIG. 16 is a closeup view of the model shown in FIG. 15 from a first side;

FIG. 17 is a closeup view of the model shown in FIG. 15 from a second side;

FIGS. 18, 19, and 20 are corresponding images showing the sleeve and crown together in accordance with exemplary embodiments of the present disclosure; and

FIG. 21 is an illustration showing a method for applying the sleeve and crown to a prepared tooth in accordance with exemplary embodiments of the present disclosure.

### DETAILED DISCLOSURE

In describing exemplary embodiments of the present disclosure illustrated in the drawings, specific terminology is employed for sake of clarity. However, the present disclosure is not necessarily intended to be limited to the specific terminology so selected, and it is to be understood that each specific element includes all technical equivalents which operate in a similar manner.

The present disclosure relates to a pre-fabricated permanent dental crown restoration that may be utilized as part of a kit of prefabricated crowns and sleeves and may be installed in a single-visit. While certain details are not described repeatedly in each section, for the purpose of providing a more concise disclosure, it is to be understood that details of each section may be mixed and matched, and in particular, elements described in one section may be substituted for similar or corresponding elements described in another section.

According to exemplary embodiments of the present invention, pairs of pre-fabricated crowns and sleeves are prefabricated in a variety of different sizes and pigment shades and are added to a kit that is provided to a dentist. When a patient requires a crown, the tooth is prepped, an appropriately sized and colored crown and its associated sleeve are bonded to the prepared tooth in the manner described herein, without the patient having to come back for a second visit and without requiring the dentist to purchase expensive in-office milling equipment.

As a first step, an affected tooth is prepared, for example, by drilling away material that is diseased or damaged so as to leave a prepared stump of healthy and structurally sound tooth material.

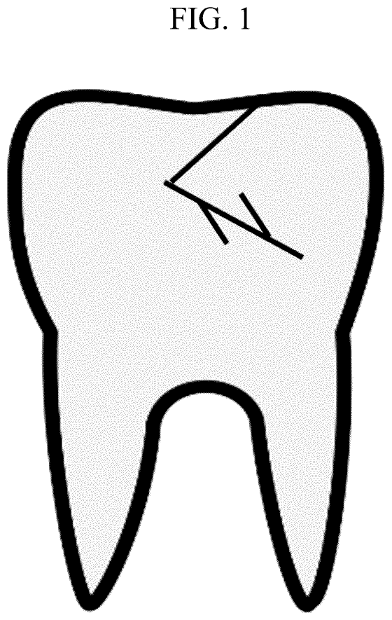

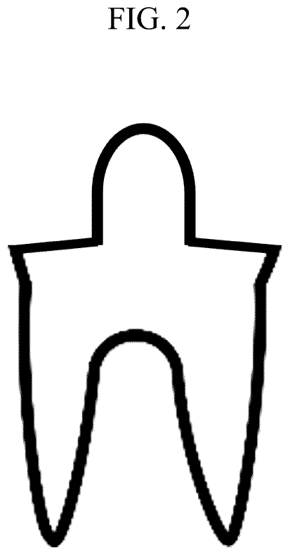

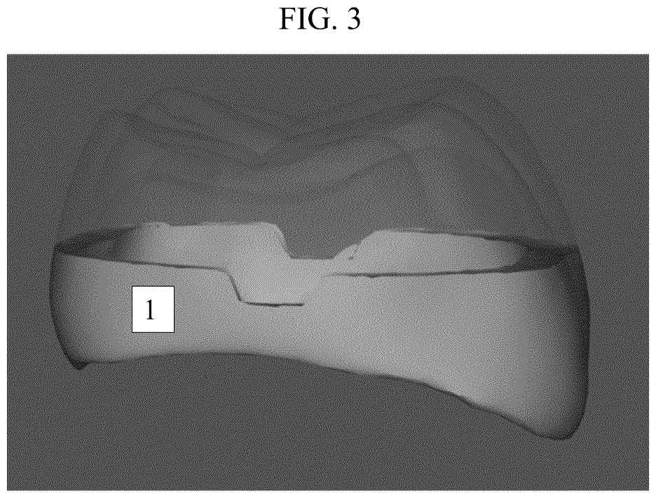

FIG. 1 is a symbolic illustration of a diseased or damaged tooth. FIG. 2 is a symbolic illustration of a prepared tooth. FIG. 3 is an image of a sleeve 1 in accordance with exemplary embodiments of the present disclosure.

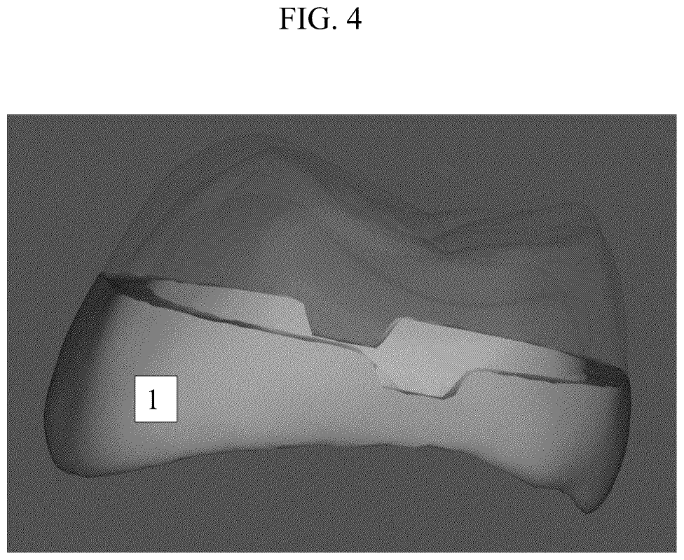

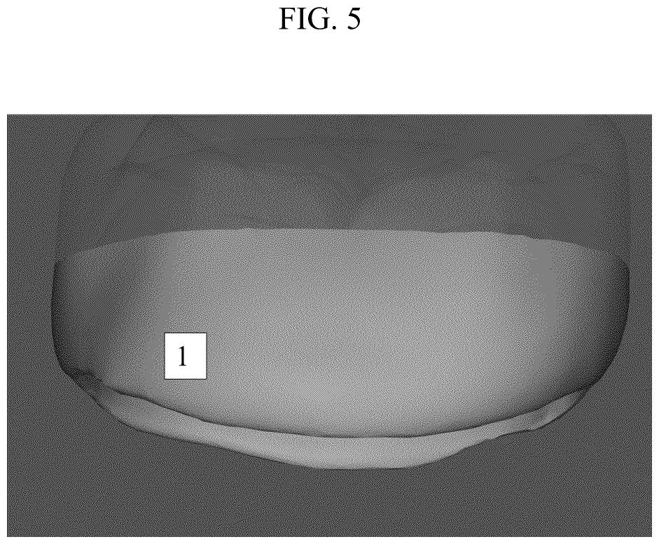

After the tooth is prepared, the sleeve 1 is placed over the prepared tooth and dental cement is added (e.g., a glass ionomer light-curing cement). The sleeve 1 may be substantially ring shaped and may have a gum-facing surface that appears as a bottom portion of a crown. The sleeve 1 may be relatively short from top to bottom and a portion of the prepared tooth might extend higher than the sleeve. The sleeve 1 may be shaped substantially as depicted in FIG. 3 which shows a left elevation of the sleeve 1 or in FIG. 4 which shows a right elevation of the sleeve 1. FIG. 5 shows a front elevation of the sleeve 1.

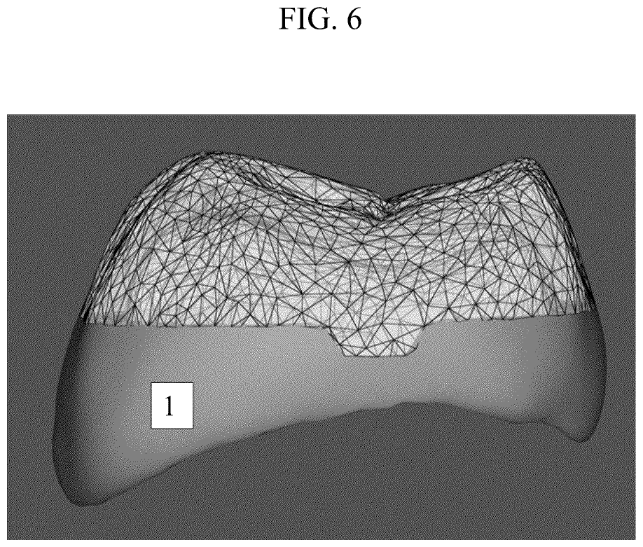

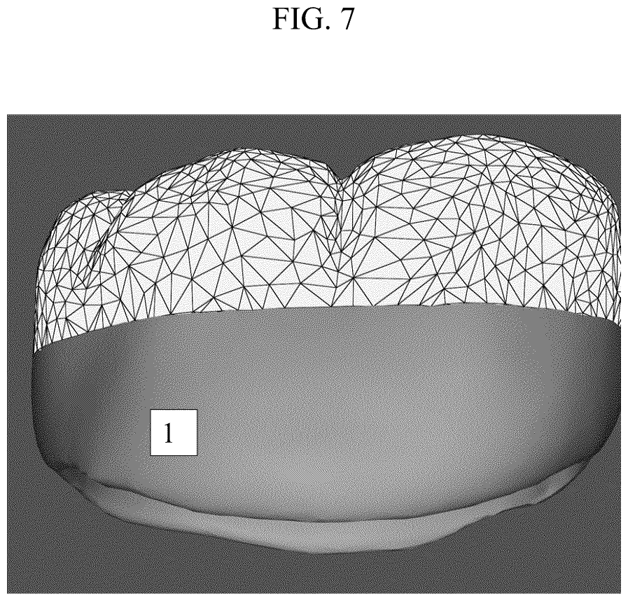

The sleeve 1 is configured to be mated to a crown 2. FIG. 6 shows the sleeve 1, as shown in FIG. 4, but having a symbolic representation of a crown connected thereto. Similarly, FIG. 7 shows the sleeve 1, as shown in FIG. 5, but having a symbolic representation of a crown connected thereto.

For example, the sleeve 1 might be only about 2 mm in height in the interproximal areas and roughly 3.90 mm on the buccal/lingual sides, so there may also be a portion of the prep extending above the sleeve which will be encapsulated by the second part crown 2 placement on top of the sleeve 1. Since the sleeve 1 is open at the top (the occlusal side), light may be easily used to cure the cement that is disposed between the sleeve 1 and the prepared tooth though the opening in the sleeve 1. Thereafter, the prefabricated crown 2 is placed on top of the sleeve. Additional cement may be administered underneath the crown 2 and pressed into place.

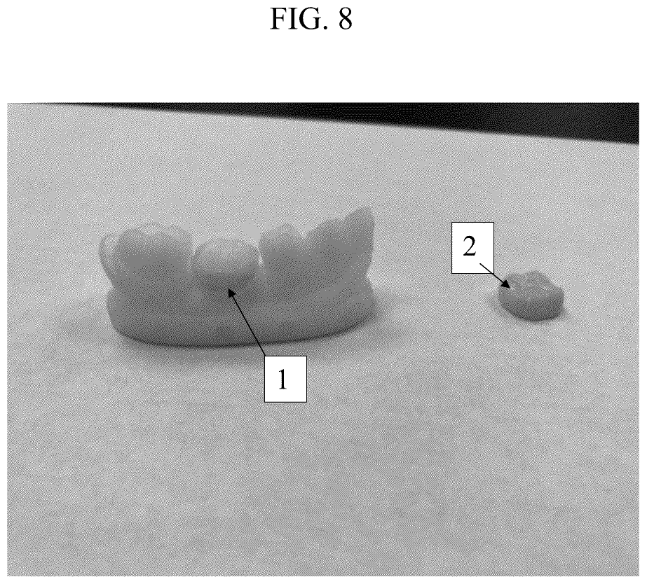

FIG. 8 is an image showing a model of a prepared tooth with a sleeve 1 disposed thereon, the crown top 2 is located besides the model.

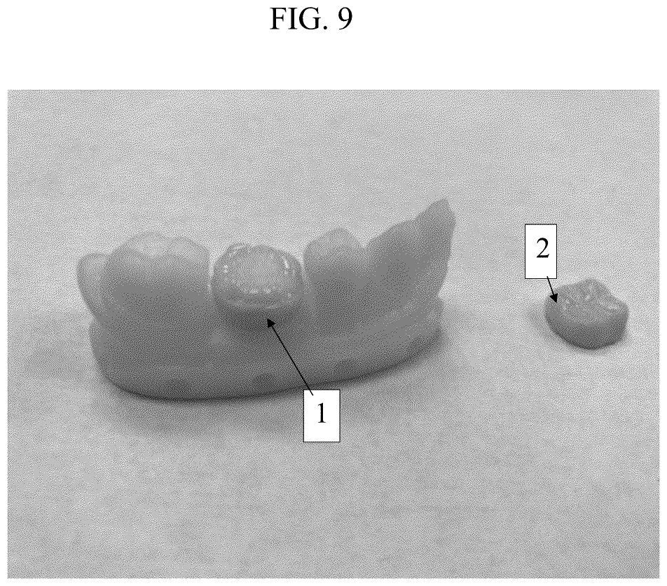

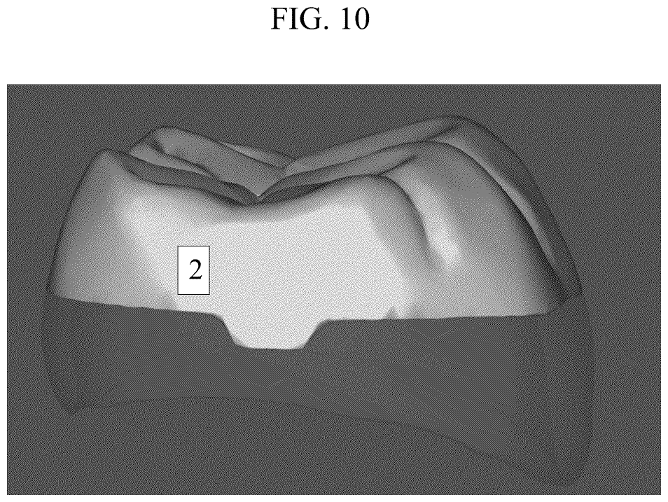

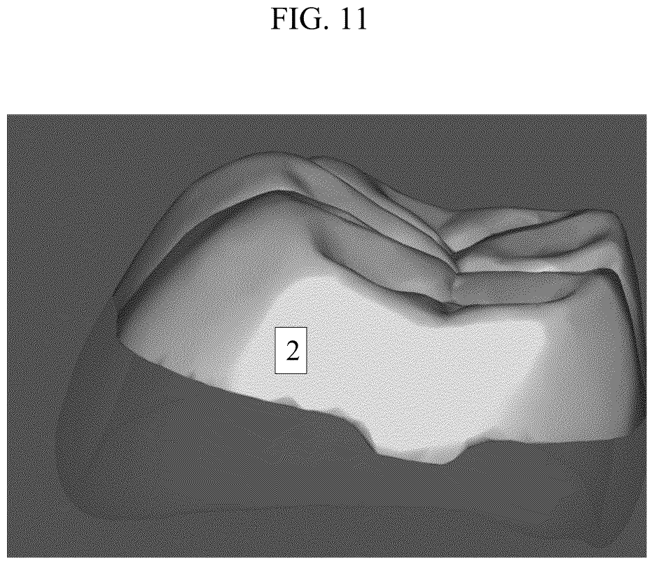

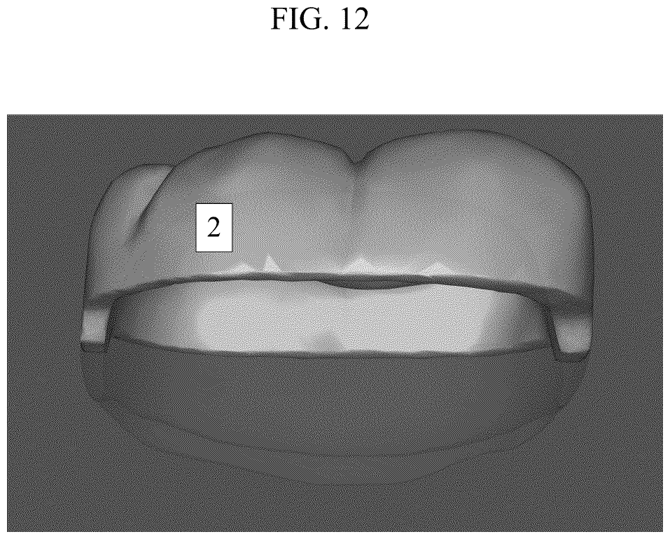

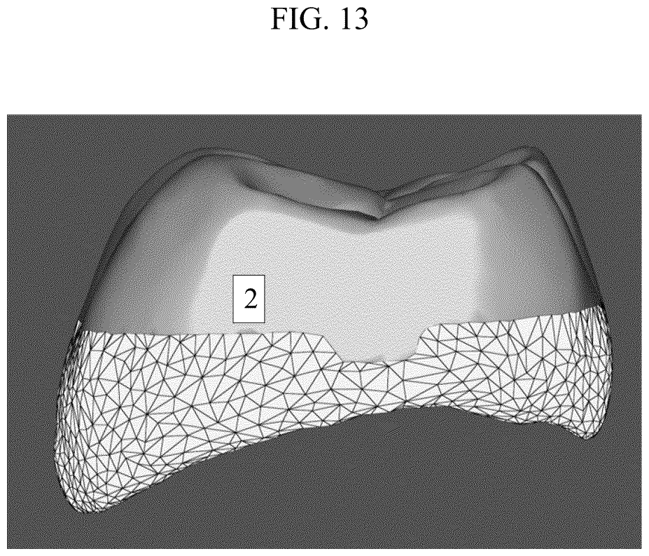

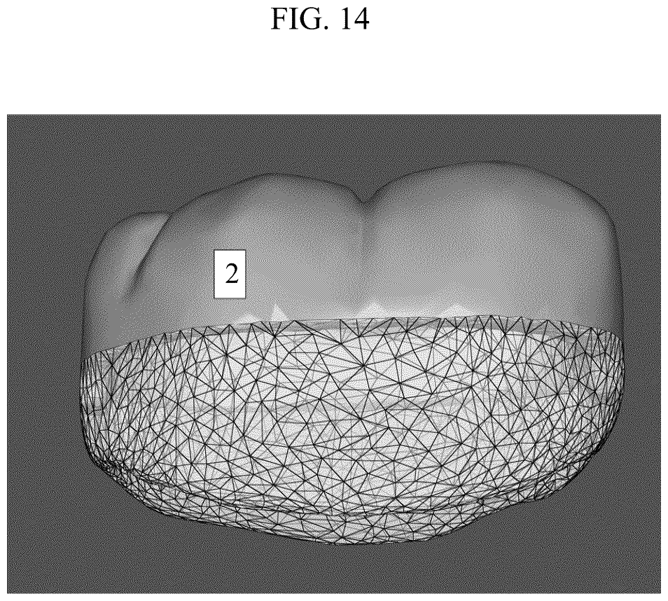

FIG. 9 is a closeup view of the model shown in FIG. 8. FIG. 10 is a first side elevation view of the crown 2 discussed above. FIG. 11 is a second side elevation view of the crown 2 discussed above. FIG. 12 is a third side elevation view of the crown 2 discussed above. FIGS. 13 and 14 are corresponding images of the sleeve 2 including symbolic representation of the sleeve 1 connected thereto.

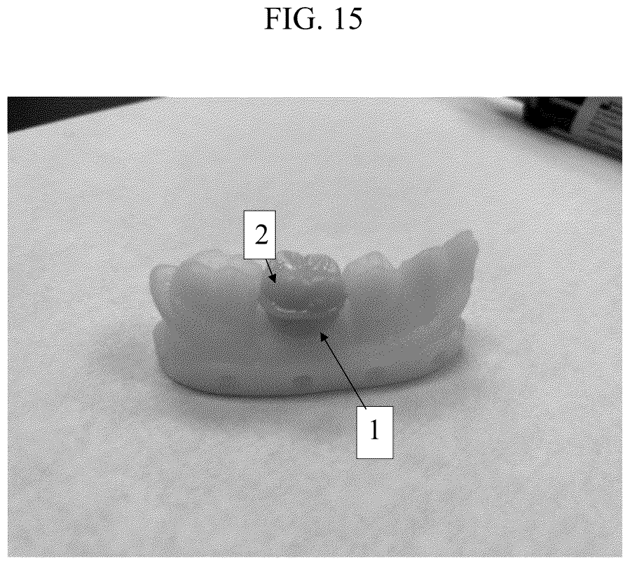

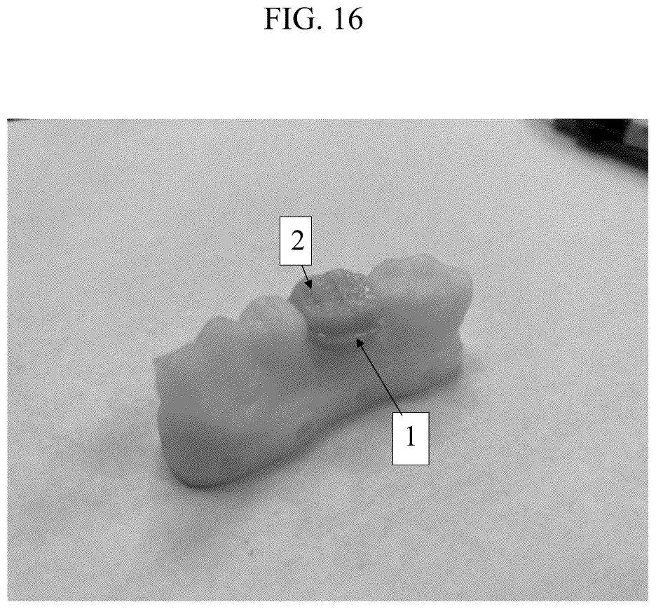

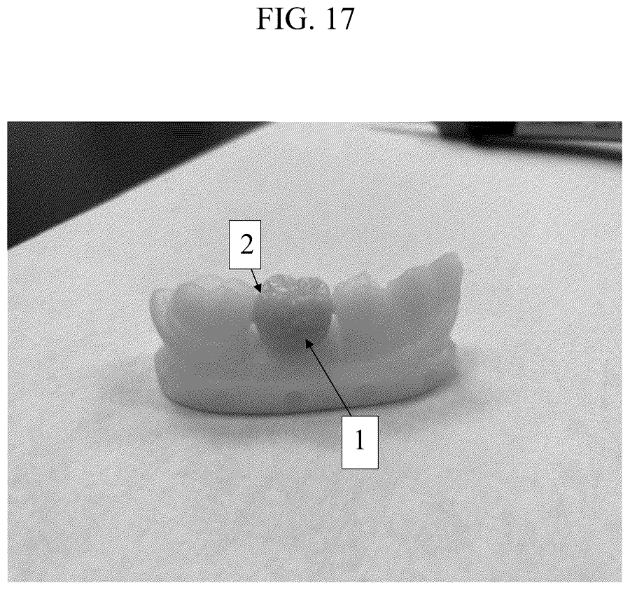

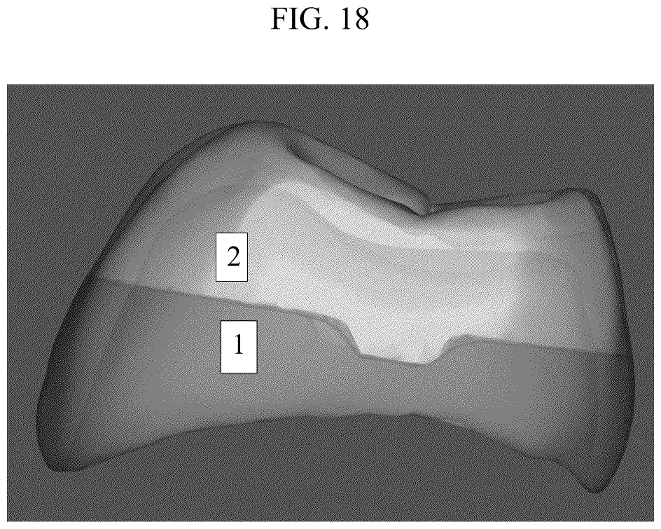

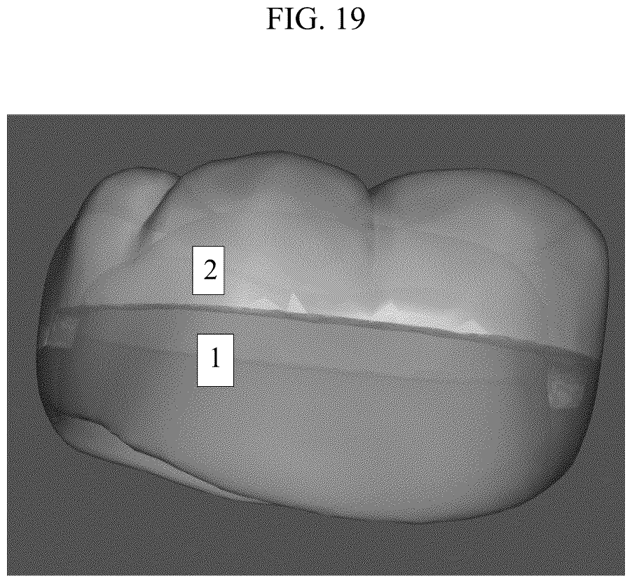

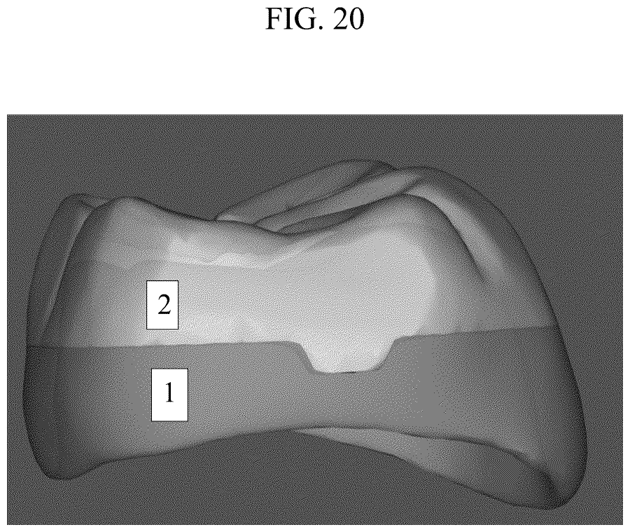

FIGS. 15 and 16 show views of the model in which the crown 2 has been attached to the sleeve 1, as described above. FIGS. 18, 19, and 20 are corresponding images showing the sleeve 1 and crown 2 together in accordance with exemplary embodiments of the present disclosure.

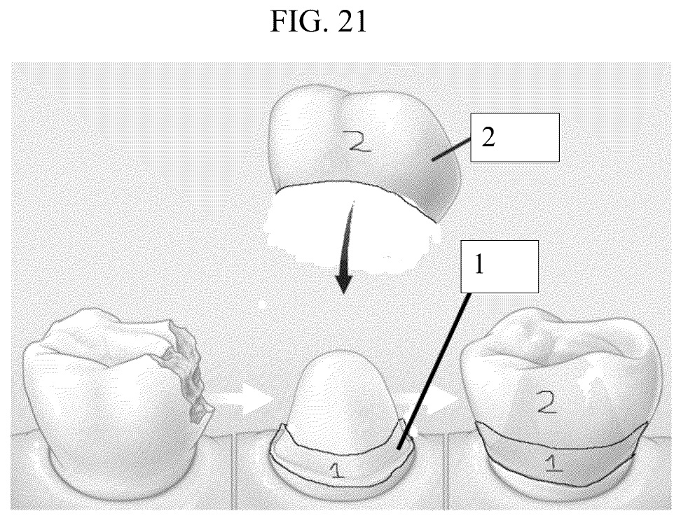

FIG. 21 is an illustration showing a method for applying the sleeve 1 and crown 2 to a prepared tooth in accordance with exemplary embodiments of the present disclosure. As shown, the damaged tooth is first prepared to the stump and then, as discussed above, the sleeve 1 is affixed to the prepared tooth. Next, the crown 2 is filled with more cement and then the crown 2 is placed over the sleeve 1 and prepared tooth. The crown 2 is then pressed over the sleeve 1. Residual cement material may then be expressed through the sides when pressed into place. The complete restoration is then shown.

The crown 2 may have the appearance of an occlusal side of a tooth and may have a center cavity (hollow) in which the cement may be placed. The crown 2 may have one or more tabs that fit into corresponding channels within the sleeve. However, this tab-and-channel configuration is optional and other embodiments might obit these features. Alternatively, there may be other mating structures used to ensure that the crown snaps into the appropriate position of the sleeve. For example, there may be semi-spheres formed on the base of the crown and corresponding depressions on the base of the sleeve.

It is noted that when the crown 2 is placed over the sleeve 1, the extruded excess cement may then be wiped away and then the structure may be light-cured so as to harden the cement.

The curing of the cement within the crown 2 segment may be performed by passing light though either the crown 2 or sleeve 1. Upon this curing step, the permanent crown is complete.

The crown 2 and sleeve 1 may be selected from among a kit of prepared parts that may be fabricated by injection molding, 3D printing, or the like.

While the figures show the repair of a lower molar, it is to be understood that any tooth may be so repaired and that for the lower teeth, the gingival-facing side may be considered the bottom while the occlusal side may be considered the top. However, for upper teeth, the gingiva-facing side may be considered the top while the occlusal side may be considered the bottom.

The sleeve may be selected from a set of sleeves designed to fit differently shaped prepared teeth and the crown may be selected from a set of crowns designed to fit differently shaped mouths and proximate teeth.

While the figures and their associated description discuss the fitting of the aforementioned sleeve-crown pair to a prepared tooth that remains attached to a natural tooth root, it is to be understood that the sleeve-crown pair may be similarly installed onto an abutment of a dental implant that has been installed into the jaw bone of the patient.

It is noted that the affected tooth may be damaged as a result of tooth decay, physical trauma, or structural break down of a natural tooth or a previously applied restoration that may occur over time with normal use. Where this damage cannot be effectively repaired by fillings, inlays, or onlays, a dental crown may be used as described herein.

As explained above, the first step may be to prepare the affected tooth. The size and shape of the prepared tooth may depend largely on the extent of the damage to the tooth as the prepared tooth must be free of damage. In accordance with exemplary embodiments of the present disclosure, the dentist may use judgement to prepare the tooth to a post of a desired size and shape.

After preparation has been completed, the shape of the prepared tooth, mouth, and surrounding teeth may be analyzed to select an appropriate size of prefabricated crown and the color of the surrounding teeth may be analyzed to select an appropriate crown color.

Selecting the appropriate size for the crown may include scanning the prepared tooth and surrounding mesial-distal area with a digital scanner. A computer may then be used to determine the optimal crown size to use such that the selected crown will fit well between the neighboring teeth and engage well with the bite of the opposite tooth. The digital scanner and computer may also be used to assess tooth color and select an appropriate crown color.

Rather than use digital sizing, a mechanical dental caliper or printed sizing gauge tool may be used to measure the optimal size of the crown to be used and a printed color chart may be used to select a desired color. However, it is to be understood that some amount of trimming and/or polishing may be performed at a later point to allow the selected crown to better fit between neighboring teeth, where necessary. It is also to be understood that the exact height at which the sleeve-crown pair fits upon the prepared tooth may be adjusted in the manner described below and so there is some degree of customization that can be performed on the selected prefabricated tooth to allow for a smaller number of crown sizes to choose between.

There may be any number of differently sized prefabricated crowns to choose from and there may be a different selection of crown sizes that depend on the type of tooth being repaired. For example, there may be some number of sizes of prefabricated crowns for molars, some number of sizes of prefabricated crowns for premolars, some number of sizes of prefabricated crowns for canines, and some number of prefabricated crowns for incisors. While it is contemplated that exemplary embodiments of the present invention may be used to crown any tooth, the crowning of molars is primarily described herein for the purpose of providing a simplified disclosure. According to one exemplary embodiment, there may be five differently sized crowns to fit each of the molars of most adults.

The crowns of each size may be made available in one of a number of different shades. The number of different shades that may be prefabricated and included as part of a dental restoration kit may depend on the type of tooth being crowned as the closeness of a color match for incisors may be easier to detect than the closeness of a color match for molars. Thus, a kit of prefabricated crowns and sleeves that would include incisors and molars may include more color shade options for incisors than for molars. Some kits may be limited to prefabricated crown and sleeve pairs for just molars, other kits may include prefabricated crown and sleeve pairs for all teeth, including incisors, canines, premolars, and molars, or any combination thereof. According to one exemplary embodiment, there may be three differently colored crowns to crown the molars of most adults.

Accordingly, the kit of prefabricated molar crowns may include crowns of five different sizes, each with three different shades, for a total of fifteen different crowns for restoring one tooth.

In the dental restoration kit, each crown may be coupled to a matching sleeve and so the optimal selection of crown size and color may be made and picked from the dental restoration kit along with its matched sleeve. However, in the dental restoration kit, each crown need not be pre-matched with a proper sleeve and in that case, a kit guide may be used to select an appropriate sleeve size for the desired crown.

The cement discussed above may be a light-curing cement, e.g., UV curing cement, and may have a high Young's modulus. This cement may include a composite resin such as a glass ionomer. The cement may have the same Young's modulus as the crown and sleeve.

It is noted that the crown may be made of a base material such as a polymer with ceramic particles dispersed therein. Traditionally, crowns may be made of partially stabilized zirconia (zirconium dioxide ZrO₂+Yttrium Oxide Y₂O₃) or porcelain fused to metal (PFM) which provide for a strong crown having a realistic tooth-like appearance. However, to better allow for trimming/polishing, exemplary embodiments of the present invention may construct the prefabricated crowns using a polymer base, which may facilitate trimming/polishing and may also allow for fabrication by injection-molding or printing, which would not be practical for zirconia or porcelain crowns. The polymer base may be impregnated with ceramic particles and/or glass particles, or strong nanomaterials, to provide the crown with an enduring hardness that is resistant to chipping and cracking. For example, the particles of ceramic and/or glass may comprise 40-85% of the total volume of the impregnated polymer. Any polymer may be used for this purpose.

Provided below are tables showing examples of suitable materials that may be used along with their various properties.

TABLE 1

| | | Composition by Weight | | |
|---|---|---|---|---|
| Material Type | Material | Filler | Polymer | Manufacturer |
| Resin | Lava - | 80% Silica and | 20% (Bis-GMA, | 3M, ESPE, USA |
| Composite | Ultimate | Zirconia nano | UDMA, Bis-EMA, | |
| CAD CAM | | particles | TEGDMA) | |
| Blocks | Shofu | 61% Silica- | 39% UDMA + | Shofu |
| | | based glass and | TEGDMA | |
| | | silica | | |
| | Cerasmart | 71% Silica and | 29% Bis-MEPP, | GC Dental |
| | | barium glass | UDMA, DMA | Products, |
| | | nanoparticles | | Europe |
| | Brilliant | 70% of glass | 30% Cross-linked | Coltene, |
| | Crois | and amorphous | methacrylates (Bis- | Switzerland |
| | | silica | GMA, Bis-EMA, | |
| | | | TEGMA) | |
| | Grandio | 86% | 14% | Voco |
| | Blocs | Nanohybrid | UDMA + | GmbH |
| | | fillers | DMA | |
| Polymer Infiltrated | Vita | 86% Ceramic | 14% | Vita Zahnfabrik, |
| Ceramic Network | Enamic | | UDMA + | Germany |
| (PICN) Ceramic | | | TEGDMA | |
| Pure PEEK | Ceramill PEEK | 0% | 100% PEEK | Juvora, UK |
| Ceramic filled | Dentokeep | 20% TiO₂ | 80% PEEK | Nt-trading |
| PEEK | | | | Germany |
| Feldspathic | Vitablocs | 100% Fine- | 0% | Vita Zahnfabrik, |
| Ceramic | Mark II | particle feldspar | | Germany |
| Block | | ceramic | | |

TABLE 2

| | | | Nano- | Elastic | Manuf. | Measured |
|---|---|---|---|---|---|---|
| Material | | Microhardness | hardness | Modulus | Filler | Filler |
| Type | Material | (Kg/mm²) | (GPa) | (GPa) | (wt %) | (wt %) |
| Resin | Lava | 112.6 | 1.25 | 12.14 | 80 | 74.8 |
| Composite | Shofu | 73.12 | 0.775 | 8.79 | 61 | 63 |
| CAD/CAM | Cerasmart | 80.06 | 0.81 | 10.36 | 70 | 66.1 |
| blocks | Brilliant | 82.61 | 0.85 | 10.98 | 71 | 70.1 |
| | Crios | | | | | |
| | Grandio | 121.8 | 1.3 | 14.8 | 86 | 84.6 |
| | Blocs | | | | | |
| Polymer Infiltrated | Vita Enamic | 203.1 | 3.1 | 34.56 | 86 | 85.1 |
| Ceramic Network | | | | | | |
| (PICN) Ceramic | | | | | | |
| Pure PEEK | Ceramill | 25.7 | 0.317 | 2.53 | 0 | 0 |
| | PEEK | | | | | |
| Ceramic | Deentokeep | 27.74 | 0.34 | 3.43 | 20 | 27.5 |
| filled PEEK | | | | | | |
| Feldspathic | Vitablocs | 502.4 | 6.83 | 47.7 | 100 | 100 |
| Ceramic Block | Mark II | | | | | |
| Enamel | Enamel | 313.3 | 4.03 | 59.7 | — | — |
| Dentine | Dentine | 62.3 | 0.76 | 16.5 | — | — |

TABLE 3

| | Subject | Predicate | | | | |
|---|---|---|---|---|---|---|
| | Device | Device | | | Ref. Device | |
| | VarseoSmile | CAD/CAMouflage | Ref. Device | | Varseo | |
| | Crown Plus, | Milling | Dentca | Ref. Device | Smile | Substantl. |
| | BEGO | Block, | Denture | Sinfony, | Temp, | Equiv. w/ |
| | Bremer | Prismatik | Base, | ESPE | BEGO | Predicate |
| Parameter | Goldschlagerei | Dentalcraft | Dentca | Dental AG | Bremer | Device |
| Product | EBF | EBF | EBI | EBF | EBG | Substantl. |
| Code | | | | | | Equiv. |
| Regulation | 872.3690 | 872.3690 | 872.3760 | 872.3690 | 872.3770 | Substantl. |
| Number | | | | | | Equiv. |
| Reg. | Class II | Class II | Class II | Class II | Class II | Substantl. |
| Class | | | | | | Equiv. |
| Indication | Indirect | Indirect | Light-cured | Veneering | Resin for | Very |
| for Use | Restorative | Restorative for | resin for | & complete | fab. of | Similar |
| | for fabricated | fabricated | fabrication | crowns and | temp. | |
| | permanent | temporary and | and repair | bridges | rest. | |
| | restorations | permanent | of dentures | | | |
| | | restorations | and | | | |
| | | | baseplates | | | |
| Material | Methacrylate | Polymer | Methacrylate | Methacrylate | Methacrylate | Very |
| | polymer | resin | polymer | polymer | polymer | Similar |
| | resin | | resin | resin | resin | |
| | (dimetha- | | (dimetha- | (dimetha- | (dimetha- | |
| | crylate) | | crylate) | crylate) | crylate) | |

Chemical Composition

| | | | | | | |
|---|---|---|---|---|---|---|
| Chem | Methacrylate | Polymer | Methacrylate | Methacrylate | Methacrylate | Very |
| Comp. | polymer | resin with | polymer | polymer | polymer | Similar |
| | resin with | fillers and | resin with | resin with | resin with | |
| | photo | pigments | photo | photo | photo | |
| | indicator, | | indicator, | indicator, | indicator, | |
| | inhibitor, & | | inhibitor, & | inhibitor, & | inhibitor, & | |
| | pigments | | pigments | pigments | pigments | |

Non-Clinical Performance Testing

| | | | | | | |
|---|---|---|---|---|---|---|
| Flexural | >100 | >100 | 90.2 | unknown | >100 | Substantl. |
| Strength | MPa | MPa | MPa | | MPa | Equiv. |
| Water | <40 | <40 | 14 | unknown | <40 | Substantl. |
| Absorption | μg/mm³ | μg/mm³ | μg/mm³ | | μg/mm³ | Equiv. |
| Water | <7.5 | <7.5 | 1.3 | unknown | <7.5 | Substantl. |
| Solubility | μg/mm³ | μg/mm³ | μg/mm³ | | μg/mm³ | Equiv. |

Table 1 is a table illustrating examples of materials that may be used to form the crowns and/or sleeves in accordance with exemplary embodiments of the present disclosure. Shown are the material names, measured hardness, measured elastic modulus, and measured composition by weight percent. To the extent that the measured composition differs from the compositions provided in Table 1, it is noted that Table 1 shows idealized values while Table 2 shows measured values.

Table 3 is a table illustrating examples of materials that may be used to form the crowns and/or sleeves in accordance with exemplary embodiments of the present disclosure. Shown are the material names, a brief description of how these materials may be used, and other pertinent technical details.

For example, the sleeve may include the same or different materials from the crown. For example, the crown and sleeve may each include Bego Varseo (which can be 3D printed), HR smart blocks (hybrid ceramic) (injection moldable), Camouflage from Glidewell (injection moldable), GC initial LRF block (leucite reinforced glass ceramic) (machinable), tetric CAD (hybrid ceramic resin) (machinable), and/or Shofu block HC (hybrid ceramic) (machinable). Each of these aforementioned materials may be considered a polymer.

The crown may have an exterior surface that is smooth and made to look like a natural tooth having a natural pattern of cusps, grooves, and pits on the occlusal surface. The interior surface of the crown may substantially match the exterior surface of the crown so as to provide a nearly constant thickness throughout the crown, although it is to be understood that the interior surface of the crown does not necessarily have the same level of detail as the exterior surface of the crown. According to some exemplary embodiments of the present disclosure, the crown may have a nearly constant thickness throughout all side surfaces, with a somewhat larger thickness at the occlusal surface. However, it is to be understood that the thickness of the crown along the side surfaces may tapper towards the gumline and as the outer surface of the sleeve may continue to form the outer surface of the complete restoration, the tapering of the crown may continue into the sleeve.

By conforming the contours of the inner surface of the crown to the contours of the outer surface of the crown, the crown may achieve maximum structural strength while allowing for a large cavity within its inner surface.

The crown and/or sleeve may be constructed of a material that is at least partially translucent to light of a wavelength that is used to cure dental cement such as that described herein. The sleeve may have substantially the same composition as the crown. This will allow the two elements to better bond together without separation over time. Where different materials are used for the sleeve and the crown, they should have the same stiffness, for example, the same Young's modulus.

For example, the sleeve may be constructed of a polymer. The sleeve, like the crown, may be made by injection molding and so a polymer is well suited for this means of fabrication. However, the sleeve may alternatively be made by printing, casting, or milling and so the sleeve may be constructed of other materials that are at least partially translucent in the desired wavelength. According to an exemplary embodiment of the present disclosure, the sleeve may be made of the same material as the crown.

The sleeve and crown may be non-porous so as to prevent the dental cement from penetrating its interior surface and the sleeve and crown may be rigid so as to maintain its fixed shape.

It is noted that the interior pocket of the sleeve should be relatively large. This may allow for the sleeve to be relatively thin so as to enhance translucency thereof. Also, the relatively large interior pocket of the sleeve may allow for the accommodation of a larger prepared tooth post, as it is not known at the time of fabrication how large the prepared tooth post will be. However, a majority of the internal volume of the sleeve may be filled with the cement, after the restoration is complete. For example, the prepared tooth may occupy 20% to 50% of the volume of the internal volume of the sleeve, with the cement occupying the remaining 80% to 50%. However, this is not necessarily the case, and the prepared tooth may occupy a majority of the internal volume of the sleeve, for example, between 50% and 80% thereof, with the cement occupying the remaining 50% to 20% of the internal volume of the sleeve. However, as is described below, the internal cavity of the sleeve may be fully filled with the cement prior to applying the sleeve to the prepared tooth.

The cavities of the crown and sleeve are filled with a dental cement. The dental cement used should be light-curing and should have a high Young's modulus so as to be sufficiently rigid to allow for proper chewing on the crown, even when the volume of the sleeve pocket is relatively large. The dental cement, once light-cured, may occupy a substantial volume of the complete dental restoration and so for this reason, it needs to be sufficiently rigid.

Accordingly, the crown, the sleeve, and the cement should have a high Young's modulus within a range of 2 and 60 GPa. Moreover, the Young's modulus of the crown, the sleeve, and the cement should substantially match each other. For example, the Young's modulus of the sleeve should be within +/−3% of that of the crown. The Young's modulus of the cement should be within 1% to 35% of that of the sleeve, as the matching between the Young's modulus of the cement to the sleeve is less critical than that of the sleeve to the crown.

As discussed above, the crown and sleeve may be shaded with one of a selection of particular colors.

Exemplary embodiments of the present disclosure may provide premade crowns and sleeves of one of a number of different shades. There are 16 shades within Vita Pan Classical Shade Guide and so exemplary embodiments of the present disclosure may have as many as 16 differently shaded crowns and sleeves. However, this many shades might not be necessary as 3 different shades may be used to match with up to 85% of the population, with molar crowns and sleeves requiring fewer shades than other teeth as it may be harder to perceive shading in such teeth.

Examples of suitable dental cements having a high Young's modulus may include GC FujiCEM. Suitable dental cements may be light-curing, such as infra-red or ultraviolet light curing. The dental cement may include a silane additive, which may be used to increase polymer bond. The dental cement may be a glass ionomer material that may include one or more of, for example, silica (SiO₂), alumina (Al₂O₃), aluminum fluoride (AlF₃), calcium fluoride (CaF₂), sodium fluoride (NaF), aluminum phosphate (AlPO₄), barium oxide, strontium oxide, polyacrylic acid, a copolymer of acrylic acid, other carboxylic acids (e.g., itaconic acid or maleic acid), and/or tartaric acid.

It is noted that there might be no elements disposed between the crown and sleeve other than the aforementioned adhesive and the interior surface of the crown and the exterior surface of the sleeve may be so shaped for precise mating. Thus, according to exemplary embodiments of the present disclosure, no structure of plastic or metal, whether rigid or mesh, is disposed between crown and sleeve, other than perhaps a thin layer of dental cement or some other dental adhesive. It is further noted that the thin layer of adhesive is applied between crown and sleeve may be applied in a substantially liquid or gelatinous form so as to conform to the shapes and structures of the crown and sleeve and so this adhesive is not applied as a rigid and/or solid mass.

Additionally, in accordance with exemplary embodiments of the present disclosure, the sleeve itself, as described above, is substantially rigid and is formed of a contiguous and homogeneous material. Thus, the sleeve is not a fabric, mesh, chain-link, etc. For example, the sleeve may be non-porous and, as described above, may be made of a same material as the crown.

The crown may be at least partially translucent to the frequency of light used to cure the cement contained in its inner volume by virtue of light being able to pass through the material of its composition, rather than by being able to pass through holes or pores thereof. However, alternatively, the crown may be opaque in which case the dental cement may be cured by another means such as curing thorough the sleeve, time auto-curing or by the conduction of heat through the crown by a heating element.

It is noted that the entirety of the dental restoration may be composed of the sleeve and crown, along with the hardened dental cement and that the crown may be formed of a single uninterrupted structure and the sleeve may be similarly formed of a single uninterrupted structure. The crown and sleeve pair may together form an entirety of the outer surface of the dental restoration and no other components may be present. Moreover, the hardened cement might form no part of the outer surface of the dental restoration, thus dental cement might not be visible from the outside, once the dental restoration has been applied.

Additionally, the sleeve forms the outer surface of the dental restoration on the gingival-facing part of thereof while the crown forms the outer surface of the dental restoration on the occlusal side thereof and so the crown might not overlap the sleeve, in side view.

Exemplary embodiments described herein are illustrative, and many variations can be introduced without departing from the spirit of the disclosure or from the scope of the appended claims. For example, elements and/or features of different exemplary embodiments may be combined with each other and/or substituted for each other within the scope of this disclosure.

What is claimed is:

1. A dental restoration device, comprising:
a sleeve having an exterior surface and an interior pocket that is at least partially filled with a dental cement; and
a crown having an exterior surface and an interior pocket that is at least partially filled with a dental cement, the crown abutting the sleeve,
wherein the sleeve forms an outer surface of the dental restoration device on a gingival-facing part of thereof while the crown forms the outer surface of the dental restoration on the occlusal side thereof,
wherein the crown has an occlusal surface and a sidewall surface forming the interior pocket therein, and
wherein the sleeve is substantially ring-shaped and the crown is substantially cup shaped.

2. A method of performing a dental restoration, comprising:
preparing an affected tooth;
filling a substantially ring-shaped sleeve with a first light-curing dental cement;
placing the sleeve over the prepared tooth such that a top of the prepared tooth extends through the ring-shape of the sleeve;
curing the first light-curing dental cement though an opening of the sleeve;
filling a substantially cup-shaped crown with a second light-curing dental cement;
placing the filled crown over the prepared tooth and sleeve;
curing the second light-curing dental cement.
